(19) United States
(12) Patent Application Publication
(10) Pub. No.: US 2009/0070161 A1
(43) Pub. Date: Mar. 12, 2009

(54) METHOD, SYSTEM AND DATA MODEL FOR MAXIMIZING THE ANNUAL PROFIT OF A HOUSEHOLD MICRO-ECONOMY

(76) Inventors: Leonardo R. Augusto, Campinas (BR); Rodrigo C. Castro, Campinas (BR); Lucas G. Franco, Campinas (BR); Aline G. Pinto, Campinas (BR); Carlos E. Seo, Campinas (BR)

Correspondence Address: HOFFMAN WARNICK LLC, 75 STATE ST, 14 FL, ALBANY, NY, 12207, US

(21) Appl. No.: 11/852,483

(22) Filed: Sep. 10, 2007

(51) Int. Cl. G06Q 10/00; G06F 17/11

(52) U.S. Cl. 705/7

(57) ABSTRACT

A periodical expense planning system, method and data model considers income, predicted and unpredicted expenses, in order to maximize final balance and profit for the analysis period. It applies multi-period linear optimization techniques, analyzing the expenses of a house cell over N periods for every period within N. The model analyzes the predicted expenses (known costs, but not necessarily the same amount on every period) of the k future periods to come, and also takes into account the actual costs incurred in the r previous periods (having that k+r=N). By doing that, the model calculates the optimal amount that can be taken away from the model in each period (i.e., money to be invested and thus give the user earnings) is achieved, and a planning for the expenses' payment is given. The variables under analysis for each period are how much to save for the next period, how much can be taken away from the model (i.e., the money to be invested), how much should be put into the system (i.e., a low-rate loan), and which expenses should be paid on each specific period.

### FIELD OF THE INVENTION

The present invention relates generally to personal finances and, more specifically, to a method, system and data model for maximizing the annual profit of a household micro-economy.

### BACKGROUND OF THE INVENTION

Middle-class citizens are always worried about how to control the monthly expenses in their normal life. The strategy of how much to save in a month to make ends meet on another future month, how to plan the expenses to be met in a period or deciding whether it's worth to take a low-rate loan to invest in a high return rate financial operation (e.g., stock options) are some of the questions asked during their financial planning. There is a need for a system to answer those questions in order to maximize the profit over a time period. Presently, products and budget spreadsheets, which intend to help controlling this financial planning, are available on the network. Such products/spreadsheets help a user to keep track of the user's financial activities and create graphics based on past data as a visual aid. Although these products enable users to map out and understand where money is going, they do not show where money can be better invested to yield the highest profit accumulation by the end of an analysis period. Nor do they suggest a plan to achieve that.

There is a present need for a new system and method for ensuring optimality of the planning, in contrast to sub-optimal planning that people create themselves with those other tools. An automated system/process is needed not only to enable a user to analyze a plan for a larger period of time, but to pick up the best path to follow down during that period and, thus, maximize final profit for the user.

### BRIEF SUMMARY OF THE INVENTION

The present invention: a method, system and data model for maximizing the annual profit of a household micro-economy.

The invention makes the periodical expense planning, considering income, predicted and unpredicted expenses, in order to maximize final balance and profit for the analysis period. To achieve that, the proposed solution applies multi-period linear optimization techniques, analyzing the expenses of a house cell over N periods for every period within N. The system and method utilizes a model which analyzes the predicted expenses (known costs, but not necessarily the same amount on every period) of the k future periods to come, and also takes into account the actual costs incurred in the r previous periods (having that k+r=N). By doing that, the system and method, utilizing the model, calculates the optimal amount that can be taken away from the model in each period (i.e., money to be invested and thus give the user earnings), and a planning for the expenses payment is provided.

The variables under analysis for each period are:
(1) the amount of money to save for the next period,
(2) the amount of money which can be taken away from the model (i.e., the money to be invested),
(3) the amount of money which should be put into the system (i.e., a low-rate loan), and
(4) which expenses should be paid on each specific period.

Although the method, system and data model has the freedom to choose to delay the payment of an expense to a future month and, of course, incur an interest fee due to the payment delay, it makes sure that all of them are honored until the end of the analysis period.

The optimization proposed needs to be run on every period so that the optimized values for the k future periods also reflects actual values of variables 1, 2, 3 and 4 for the r previous periods, thus nullifying the effects of errors for future periods. This step guarantees that deviations from the optimal plan due to unpredicted expenses are taken into account for the future periods. Performing periodical execution of the algorithm and making use of a safety threshold (included in variable 1) ensures that unforeseen expenses are easily dealt with and therefore the system is kept in positive balance. As stated above, the advantage of using this invention is to also provide an expense plan focused in maximizing the final profit for a given period, guaranteeing a positive balance.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1A depicts the method of the present invention.

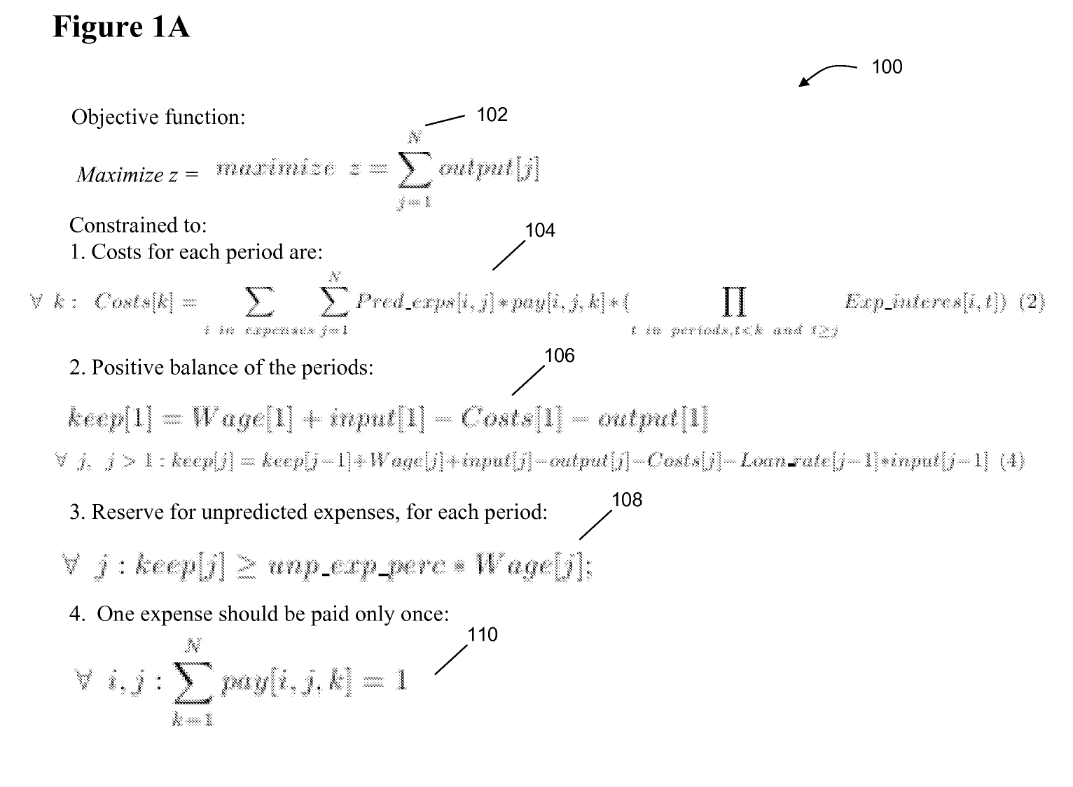

FIG. 1B depicts a continuation of the method of the present invention.

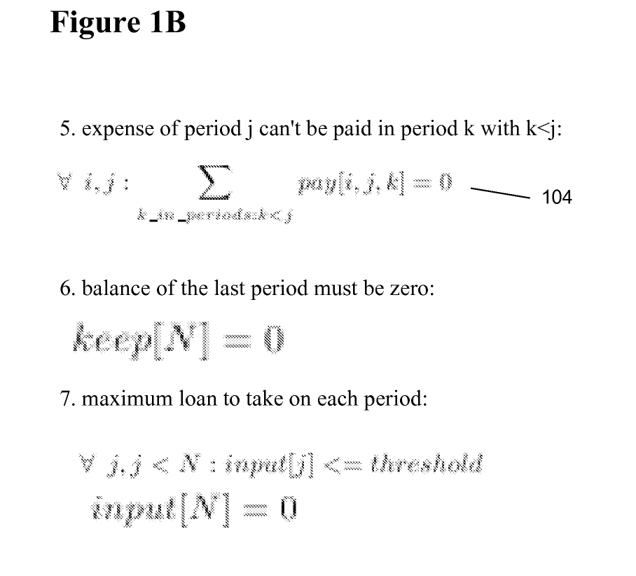

FIG. 2 depicts an Accumulated Earnings chart showing the positive results of the present invention.

The drawings are intended to depict only typical aspects of the invention, and therefore should not be considered as limiting the scope of the invention. In the drawings, like numbering represent like elements between the drawings.

### DETAILED DESCRIPTION OF THE PREFERRED EMBODIMENT OF THE PRESENT INVENTION

The present invention provides a method, a system and a data model for maximizing the annual profit of a household micro-economy.

The problem consists of defining the best expense plan in a long-term perspective in order to maximize the final profit for a middle class family. This is achieved by applying linear optimization techniques to the problem. To make the method, system and data model work for j periods, it is necessary to analyze three main aspects of the problem:
(1) the amount of money needed in addition to the usual income, e.g., the periodical wage: (input[j], wage[j]);
(2) the amount of money that need not be used to honor bills and can be invested (output[j]); and
(3) the amount of money that is needed to be saved for the next period (j+1) in order to cover its expenses and avoid the system to go into a negative balance (keep[j]). (input[j] is the amount of loans taken on period j.)

These are implemented as the present invention's main three decision variables whose values are calculated to yield the maximum profit value for a whole analysis period. In order to make periodical plans possible, the present invention utilizes two new variables which are named “support variables”. The two new variables make it possible to know which bills are paid in the current period (k) and which bills to postpone to another period (k+2, for example). These support variables are: Costs[j] and pay[i,j,k]. Costs[j] represents the summation of the bills that are really going to be paid on period j (not necessarily the total value of all of the originally incurred on period j). The other one (pay[i,j,k]) is a binary variable to decide if the ith bill from period j will be paid in period k, where k>=j. For example, i represents the school bill, j represents the second period and k be the fourth period. If pay[school, 2, 4] equals 1, this means that the user is able to pay the school bill of period 2 only on period 4, so the user will postpone the payment by two months. Of course that in this case two months of interest fee will incur on the school bill of period 2, but the system, process and data model of the present invention takes that into account. The variable that actually drives the method, system and data model is the objective function (Z). The algorithm will optimize the value of the objective function, which should be the sum of the investments, thus the sum of the output[j] multiplied by the bank's investment rates.

To run the model, the present invention uses as the input:
a. a matrix containing the costs of each bill for each period;
b. an array containing the loan rates from the bank for each period;
c. an array containing the periodical interest rates of the investment being used in the model;
d. an array with the value of the wage for each period; and
e. a matrix containing the interest fee for each of the bills to be paid, if the user's payment is delayed.

The value of variables output, input and keep of period j are going to be used for the calculation of the variable keep for period j+1, considering that a percentage of that period's wage is always kept (the percentage can be defined by the user, the recommend percentage is 10%).

In the first period, the value of keep will be the difference between wage[1]+input[1] and Costs[1]+output[1].

In order to prevent the model from not having a feasible solution, the present invention enforces the following constraints:
a. a maximum loan per period;
b. making sure that a bill is paid only once;
c. a loan can not be taken in the last period, since that's the final analysis period; and
d. there can not be a fund reserve in the last period, i.e., keep[N]=0.

Mathematically speaking, the method, system and data model of the present invention has the objective function constrained to costs for each period which are:
a. positive balance of the period;
b. reserve for unpredicted expenses, for each period;
c. one expense should be paid only once;
d. expense of period j can't be paid in period k with k<j;
e. balance of the last period must be zero; and
f. maximum loan to take on each period.

Making a plan of how to manage expenses is obvious and help for doing that can be provided by many of the spreadsheets and software available in the Internet. The innovative part of the present invention's solution is to use a linear optimization algorithm focused on maximizing profit and, based on that, propose an expenses plan.

The present invention introduces a method, system and data method having the steps of:
1. deciding whether it is convenient to pay a bill in the current period or postpone it to the next month in order to invest that money;
2. deciding if it is worth to take a low-rate loan in the current period in order to make an investment due to a high investment return rate; and
3. deciding how much on each period should be invested to enhance the earnings.

In order to demonstrate the advantage of using the model proposed, two examples are shown and compare the optimal results obtained from the model output to the sub-optimal results obtained from a plan that could be done by using a simple budget spreadsheet of the prior art. The percentage of the wage used to constrain the value of keep (i.e., a floor) for each period is 10%.

Z is the value of the present invention's objective function, i.e., all of the earnings that came from the leftover of that period plus its investment rates over the N=12 periods. For example, the first period has a leftover of $525. This will be invested on period 1 and, by the end of period 12, those having $525 will have a $94.67 profit, thus making a total of $619.67 by the end of the last period.

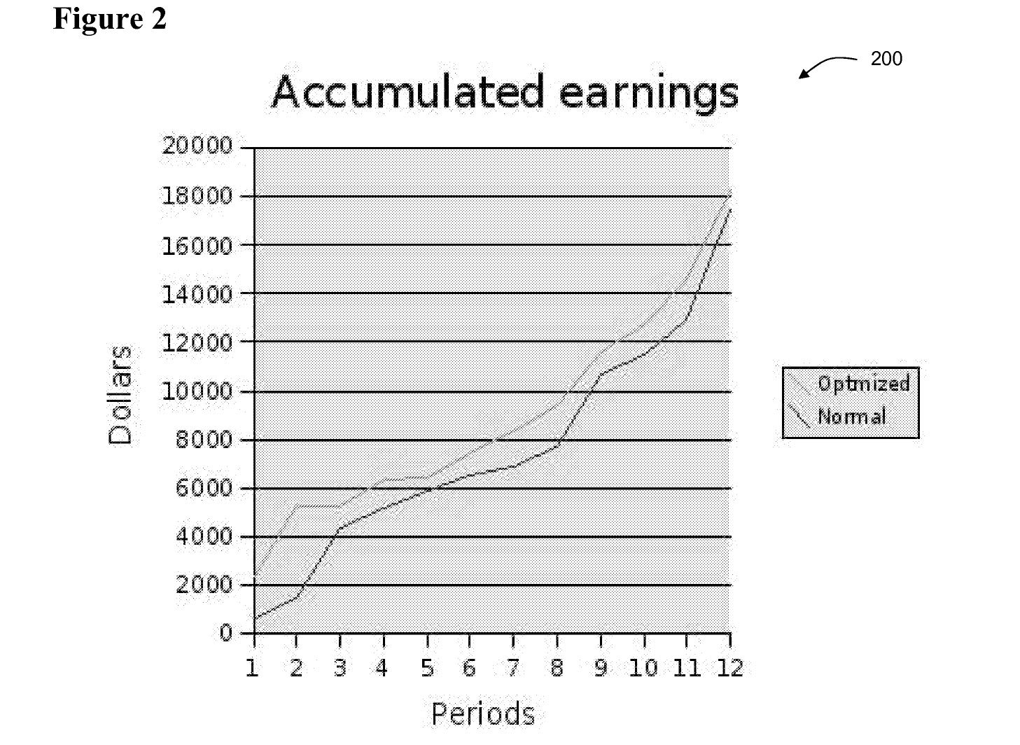

According to the results given, it is clear that a gain of 4.87% was achieved when the present invention's optimization system, method and data model was applied, in contrast to the sub-optimal results. Comparing the accumulated earnings for each period for each plan, which is actually needed to be compared, and because the present invention's optimization system, method and data model wants to maximize the earnings throughout all of the periods, the following graphic is shown in FIG. 2 where the optimized earnings (utilizing the method, system and data model of the present invention) and the normal earnings are shown, graphically.

Using the same problem data as in tables Table 1 through Table 7 and considering the new unpredicted expenses as shown in Table 7, the present invention's optimization system, method and data model have the following results:

TABLE 1
Expenses Interest Rate
Problem
data

| | |
|---|---|
| Interest rate | Period |

| Expense | 1 | 2 | 3 | 4 | 5 | 6 | 7 | 8 | 9 | 10 | 11 | 12 |
|---|---|---|---|---|---|---|---|---|---|---|---|---|
| Rent | 1.07 | 1.07 | 1.07 | 1.07 | 1.07 | 1.07 | 1.07 | 1.07 | 1.07 | 1.07 | 1.07 | 1.07 |
| Transport | 1.013 | 1.013 | 1.013 | 1.013 | 1.013 | 1.013 | 1.013 | 1.013 | 1.013 | 1.013 | 1.013 | 1.013 |
| Internet | 1.02 | 1.02 | 1.02 | 1.02 | 1.02 | 1.02 | 1.02 | 1.02 | 1.02 | 1.02 | 1.02 | 1.02 |
| School | 1.04 | 1.04 | 1.04 | 1.04 | 1.04 | 1.04 | 1.04 | 1.04 | 1.04 | 1.04 | 1.04 | 1.04 |
| Massage | 1.008 | 1.008 | 1.008 | 1.008 | 1.008 | 1.008 | 1.008 | 1.008 | 1.008 | 1.008 | 1.008 | 1.008 |
| Dance | 1.012 | 1.012 | 1.012 | 1.012 | 1.012 | 1.012 | 1.012 | 1.012 | 1.012 | 1.012 | 1.012 | 1.012 |
| Telephone | 1.02 | 1.02 | 1.02 | 1.02 | 1.02 | 1.02 | 1.02 | 1.02 | 1.02 | 1.02 | 1.02 | 1.02 |
| Groceries | 1.018 | 1.018 | 1.018 | 1.018 | 1.018 | 1.018 | 1.018 | 1.018 | 1.018 | 1.018 | 1.018 | 1.018 |
| Water | 1.015 | 1.015 | 1.015 | 1.015 | 1.015 | 1.015 | 1.015 | 1.015 | 1.015 | 1.015 | 1.015 | 1.015 |
| Power | 1.02 | 1.02 | 1.02 | 1.02 | 1.02 | 1.02 | 1.02 | 1.02 | 1.02 | 1.02 | 1.02 | 1.02 |

TABLE 2
Loans Interest Rate

| | |
|---|---|
| Loans | Period |

| | 1 | 2 | 3 | 4 | 5 | 6 | 7 | 8 | 9 | 10 | 11 | 12 |
|---|---|---|---|---|---|---|---|---|---|---|---|---|
| Loan rate | 1.05 | 1.01 | 1.06 | 1.04 | 1.07 | 1.08 | 1.09 | 1.1 | 1.16 | 1.2 | 1.25 | 1.7 |

TABLE 3
Predicted Expenses Costs

| | |
|---|---|
| Pred expenses | Period |

| Expense | 1 | 2 | 3 | 4 | 5 | 6 | 7 | 8 | 9 | 10 | 11 | 12 |
|---|---|---|---|---|---|---|---|---|---|---|---|---|
| rent | $420.00 | $480.00 | $500.00 | $500.00 | $500.00 | $500.00 | $500.00 | $525.00 | $525.00 | $525.00 | $525.00 | $525.00 |
| transport | $200.00 | $200.00 | $200.00 | $250.00 | $250.00 | $250.00 | $400.00 | $245.00 | $255.00 | $255.00 | $260.00 | $560.00 |
| internet | $30.00 | $30.00 | $70.00 | $70.00 | $70.00 | $70.00 | $70.00 | $70.00 | $75.00 | $75.00 | $75.00 | $75.00 |
| School | $270.00 | $270.00 | $270.00 | $270.00 | $270.00 | $270.00 | $270.00 | $270.00 | $270.00 | $270.00 | $270.00 | $280.00 |
| massage | $20.00 | $20.00 | $20.00 | $20.00 | $20.00 | $20.00 | $25.00 | $25.00 | $25.00 | $25.00 | $25.00 | $25.00 |
| dance | $65.00 | $65.00 | $65.00 | $65.00 | $65.00 | $65.00 | $65.00 | $65.00 | $75.00 | $75.00 | $75.00 | $75.00 |
| telephone | $130.00 | $130.00 | $115.00 | $200.00 | $210.00 | $200.00 | $150.00 | $120.00 | $140.00 | $170.00 | $200.00 | $235.00 |
| groceries | $800.00 | $800.00 | $775.00 | $870.00 | $700.00 | $800.00 | $900.00 | $700.00 | $780.00 | $790.00 | $815.00 | $1.000,00 |
| Water | $90.00 | $90.00 | $85.00 | $80.00 | $80.00 | $75.00 | $70.00 | $75.00 | $80.00 | $85.00 | $85.00 | $90.00 |
| Power | $150.00 | $160.00 | $170.00 | $170.00 | $175.00 | $180.00 | $190.00 | $190.00 | $185.00 | $170.00 | $170.00 | $180.00 |

TABLE 4
Total Expenses per Period

| | |
|---|---|
| Total | |
| expenses | Period |

| | 1 | 2 | 3 | 4 | 5 | 6 |
|---|---|---|---|---|---|---|
| expenses | $2.175,00 | $2.245,00 | $2.270,00 | $2.495,00 | $2.340,00 | $2.430,00 |
| | 7 | 8 | 9 | 10 | 11 | 12 |
| expenses | $2.640,00 | $2.285,00 | $2.410,00 | $2.440,00 | $2.500,00 | $3.045,00 |

TABLE 5
Safety Reserve: This is a Safety 10%-of-the-Wage Reserve

| Safety | | | | | | | | | | | | |
|---|---|---|---|---|---|---|---|---|---|---|---|---|
| reserve | | | | | | | | | | | | Period |
| | 1 | 2 | 3 | 4 | 5 | 6 | 7 | 8 | 9 | 10 | 11 | 12 |
| Reserve | $300.00 | $300.00 | $500.00 | $300.00 | $300.00 | $300.00 | $300.00 | $300.00 | $550.00 | $300.00 | $397.00 | $794.00 |

TABLE 6
Wage

| | |
|---|---|
| Income | Period |

| | 1 | 2 | 3 | 4 | 5 | 6 | 7 | 8 | 9 | 10 | 11 | 12 |
|---|---|---|---|---|---|---|---|---|---|---|---|---|
| Wage | $3.000,00 | $3.000,00 | $5.000,00 | $3.000,00 | $3.000,00 | $3.000,00 | $3.000,00 | $3.000,00 | $5.500.00 | $3.000,00 | $3.970.00 | $7.940.00 |

TABLE 7
Accumulated Investment Interest Rate

| | |
|---|---|
| Investments | Period |

| | 1 | | 3 | 4 | 5 | 6 | 7 | 8 | 9 | 10 | 11 | 12 |
|---|---|---|---|---|---|---|---|---|---|---|---|---|
| Acc. | $1.18033 | $1.14852 | $1.13210 | $1.11989 | $1.10400 | $1.09971 | $1.08335 | $1.06902 | $1.05395 | $1.04290 | $1.02921 | $1.01500 |
| In- | | | | | | | | | | | | |
| vest | | | | | | | | | | | | |
| rate | | | | | | | | | | | | |

### EXAMPLE 1

Considering the above data and that in the sub-optimal plan all of the bills are going to be paid in the expected period, a safety reserve is going to be done, and all of the leftovers are going to be invested, the results are as follows:

### Sub-Optimal Plan Results

Results

Period

| | 1 | 2 | 3 | 4 | 5 | 6 | 7 | 8 | 9 | 10 | 11 | 12 |
|---|---|---|---|---|---|---|---|---|---|---|---|---|
| Leftovers | $525.00 | $755.00 | $2.530.00 | $705.00 | $660.00 | $570.00 | $360.00 | $715.00 | $2.840,00 | $810.00 | $1.373,00 | $4.498,00 |
| Z by period | $619.67 | $867.13 | $2.864.22 | $789.53 | $728.64 | $626.83 | $390.01 | $764.35 | $2.993,23 | $844.75 | $1.413,11 | $4.565,47 |

Z is the value of the objective function, i.e., all of the earnings that came from the leftover of that period plus its investment rates over the N=12 periods. For example, the first period has a leftover of $525. This will be invested on period 1 and, by the end of period 12, $525 will have a $94.67 profit, thus making a total of $619.67 by the end of the last period.

The optimized values are as shown below:

### Optimal Results

Values

Period

| | 1 | 2 | 3 | 4 | 5 | 6 |
|---|---|---|---|---|---|---|
| out by period | $2.010,00 | $2.489,34 | $0.00 | $953.73 | $75.91 | $980.00 |
| keep by period | $300.00 | $300.00 | $500.00 | $300.00 | $300.00 | $300.00 |
| in by period | $0.00 | $2.871,29 | $0.00 | $0.00 | $0.00 | $0.00 |
| Leftovers | $2.010,00 | $2.489,34 | $0.00 | $953.73 | $75.91 | $980.00 |

| | 7 | 8 | 9 | 10 | 11 | 12 |
|---|---|---|---|---|---|---|
| out by period | $773.88 | $1.050,00 | $2.021,47 | $1.165,00 | $1.733,00 | $3.711,17 |
| keep by period | $300.00 | $300.00 | $550.00 | $300.00 | $397.00 | $0.00 |
| in by period | $0.00 | $0.00 | $0.00 | $0.00 | $0.00 | $0.00 |
| Leftovers | $773.88 | $1.050,00 | $2.021,47 | $1.165,00 | $1.733,00 | $3.711,17 |

| | |
|---|---|
| Results | Period |

| | 1 | 2 | 3 | 4 | 5 | 6 | 7 | 8 | 9 | 10 | 11 | 12 |
|---|---|---|---|---|---|---|---|---|---|---|---|---|
| Z by period | $2.372,47 | $2.859,05 | $0.00 | $1.068,07 | $83.81 | $1.077,71 | $838.38 | $1.122,48 | $2.130,53 | $1.214,98 | $1.783,62 | $3.766,84 |

| | |
|---|---|
| Total Z | $18.317.93 |

According to the results given, it is clear that a gain of 4.87% was achieved when the optimization model of the present invention was applied, in contrast to the sub-optimal results of the prior art. Comparing the accumulated earnings for each period for each plan, which is actually what should be compared since the system and method of the present invention are designed to maximize the earnings throughout all of the periods, the following table results from that comparison:

Period

| 23456789101112 | | | | | | | |
|---|---|---|---|---|---|---|---|
| Optmized | $2.372,47 | $5.231,51 | $5.231,51 | $6.299,59 | $6.383,39 | $7.461,11 | $8.299,48 |
| Normal | $619.67 | $1.486,80 | $4.351,02 | $5.140,55 | $5.869,18 | $6.496,02 | $6.886,02 |

| 23456789101112 | | | | | |
|---|---|---|---|---|---|
| Optmized | $9.421,96 | $11.552,49 | $12.767,47 | $14.551,09 | $18.317,93 |
| Normal | $7.650,38 | $10.643,60 | $11.488,35 | $12.901,46 | $17.466,93 |

According to the results given, it is clear that a gain of 4.87% was achieved when the present invention's optimization system, method and data model was applied, in contrast to the sub-optimal results. Comparing the accumulated earnings for each period for each plan, the following graphic is shown:

Using the same problem data as in tables [1] through [7] and considering the new unpredicted expenses as shown in Table [8], the following results are achieved:

TABLE 8
Unpredicted expenses per period

| Unpredicted | | | | | | | | | | | | |
|---|---|---|---|---|---|---|---|---|---|---|---|---|
| expenses | | | | | | | | | | | | Period |
| Expense | 1 | 2 | 3 | 4 | 5 | 6 | 7 | 8 | 9 | 10 | 11 | 12 |
| healthcare | — | — | — | — | — | — | $300.00 | — | — | — | $570.00 | — |
| Gifts | — | — | $130.00 | — | $250.00 | — | $60.00 | — | — | — | — | $500.00 |

TABLE 9
Total unpredicted expenses per period

| Total unpredicted expenses | | | | | | | | | | | | Period |
|---|---|---|---|---|---|---|---|---|---|---|---|---|
| | 1 | 2 | 3 | 4 | 5 | 6 | 7 | 8 | 9 | 10 | 11 | 12 |
| Expenses | — | — | $130.00 | — | $250.00 | — | $360.00 | — | — | — | $570.00 | $500.00 |

Sub-optimal Plan Results

| Results | | | | | | | | | | | | |
|---|---|---|---|---|---|---|---|---|---|---|---|---|
| Period | | | | | | | | | | | | |
| | 1 | 2 | 3 | 4 | 5 | 6 | 7 | 8 | 9 | 10 | 11 | 12 |
| Leftovers | $525.00 | $755.00 | $2.400,00 | $705.00 | $410.00 | $570.00 | $0.00 | $715.00 | $2.840,00 | $810,00 | $803.00 | $3.998,00 |
| Z by period | $619.67 | $867.13 | $2.717,04 | $789.53 | $452.64 | $626.83 | $0.00 | $764.35 | $2.993,23 | $844.75 | $826.46 | $4.057,97 |
| Total Z | | | | | | | | | | | | |
| $15.559,60 | | | | | | | | | | | | |

Optimal Results
Values

| Period | | | | | | | |
|---|---|---|---|---|---|---|---|
| | 1 | 2 | 3 | 4 | 5 | 6 | 7 |
| out by period | $2.010,00 | $2.158,02 | $0.00 | $953.73 | $36.52 | $980.00 | $413.88 |
| keep by period | $300.00 | $300.00 | $500.00 | $300.00 | $300.00 | $300.00 | $300.00 |
| in by period | $0.00 | $2.742.57 | $0.00 | $0.00 | $0.00 | $0.00 | $0.00 |
| Leftovers | $2.010,00 | $2.158,02 | $0.00 | $953,73 | $36.52 | $980.00 | $413.88 |

| Period | | | | | |
|---|---|---|---|---|---|
| | 8 | 9 | 10 | 11 | 12 |
| out by period | $1.050,00 | $2.021.47 | $1.165,00 | $1.163,00 | $3.211,17 |
| keep by period | $300.00 | $550.00 | $300.00 | $397.00 | $0.00 |
| in by period | $0.00 | $0.00 | $0.00 | $0.00 | $0.00 |
| Leftovers | $1.050,00 | $2.021,47 | $1.165,00 | $1.163,00 | $3.211,17 |

According to the results given, it is clear that a gain of 5.46% was achieved when the optimization model of the present invention is applied, in contrast to the sub-optimal results of the prior art. Comparing the accumulated earnings for each period for each plan, the following graphic is obtained:

| | |
|---|---|
| Period | 1 |
| 23456789 | |
| 101112 | |

| | | | | | | | |
|---|---|---|---|---|---|---|---|
| Optimized | $2.372,47 | $4.850,99 | $4.850,99 | $5.919,06 | $5.959,37 | $7.037,09 | $7.485,46 |
| Normal | $619.67 | $1.486,80 | $4.203,85 | $4.993,37 | $5.446,01 | $6.072,85 | $6.072,85 |

| | | | | | |
|---|---|---|---|---|---|
| Optimized | $8.607,93 | $10.738,47 | $11.953,45 | $13.150,42 | $16.409,75 |
| Normal | $6.837,20 | $9.830,43 | $10.675,17 | $11.501,63 | $15.559,60 |

In order to use the system, method and data model of the present invention, the user needs to input data (as described above), that is:
1. wages, if any, of the household;
2. the investment rate, retrieved from a financial study/projection, of the household;
3. the present loan rates, of the household, which is retrieved from bank's historical data of the household;
4. expenses, of the household, based upon from daily life records; and
5. unpredicted expenses, of the household, as they occur;

The system comprises a component that implements the simplex algorithm to read and solve the model of the present invention with the provided input data;
i. the system comprises a component to analyze and organize the resulting optimized data to:
   1. create graphics similar to the ones have been presented; and
   2. create a table to let users know which bills to pay on which period.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system for maximizing the annual profit of a household micro-economy comprising a component that implements the simplex algorithm to exercise the model of the present invention with the provided input data, the system comprising:
a. a component to analyze and organize the resulting optimized data to create graphics for a user to view and analyze; and
b. a component to create a table to let the user know which bills to pay on which period, the table having support variables, Costs[j] and pay[i, j, k], Costs[j] representing the summation of the bills which are to be paid on period j (not necessarily the total value of all of the originally incurred on period j), and pay[i,j,k] is a binary variable to decide if the ith bill from period j will be paid in period k, where k>=j.

2. The system of claim 1 where i is the school bill, j is the second period and k is the fourth period.

3. A method, in a system for maximizing the annual profit of a user's household micro-economy comprising a component that implements the simplex algorithm to exercise the model of the present invention with the provided input data, the system comprising a component to analyze and organize the resulting optimized data to create graphics for a user to view and analyze, and a component to create a table to let the user know which bills to pay on which period, the table having support variables, Costs[j] and pay[i,j,k], Costs[j] representing the summation of the bills which are to be paid on period j (not necessarily the total value of all of the originally incurred on period j), and pay[i, j, k] is a binary variable to decide if the ith bill from period j will be paid in period k, where k>=j, the method comprising the steps of:
a. determining the amount of money which the user has to save for the next period;
b. determining the amount of money, which the user has, which can be taken away from the money to be invested;
c. determining the amount of money which the user needs to put into the system;
d. determining which of the user's expenses should be paid on each specific period; and
e. analyzing the received data.

4. The method of claim 3 where i is the school bill, j is the second period and k is the fourth period.

5. A method for maximizing the annual profit of a household micro-economy, in a system comprising a component to analyze and organize the resulting optimized data to create graphics for a user to view and analyze, and a component to create a table to let the user know which bills to pay on which period, the table having support variables, Costs[j] and pay[i, j, k], Costs[j] representing the summation of the bills which are to be paid on period j (not necessarily the total value of all of the originally incurred on period j), and pay[i, j, k] is a binary variable to decide if the ith bill from period j will be paid in period k, where k>=j, the system further having a component which implements the simplex algorithm to read and solve the model of the present invention with the provided input data and a component to analyze and organize the resulting optimized data to create graphics similar to the ones have been presented; and to create a table to let users know which bills to pay on which period, the method comprising the steps of:
a. receiving input data wages, if any, of the household;
b. receiving input data an investment rate retrieved from a financial study/projection of the household;
c. receiving input data present loan rates of the household which may be retrieved from bank's historical data;
d. receiving input data expenses of the household which may be retrieved from daily life records; and
e. receiving input data unpredicted expenses of the household, as they occur.

6. A data model, for being utilized by a system and a method, the system comprising a component to analyze and organize the resulting optimized data to create graphics for a user to view and analyze, and a component to create a table to let the user know which bills to pay on which period, the table having support variables, Costs[j] and pay[i, j, k], Costs[j] representing the summation of the bills which are to be paid on period j (not necessarily the total value of all of the originally incurred on period j), and pay[i, j, k] is a binary variable to decide if the ith bill from period j will be paid in period k, where k>=j, the system further having a component which implements the simplex algorithm to read and solve the model of the present invention with the provided input data and a component to analyze and organize the resulting optimized data to create graphics similar to the ones have been presented; and to create a table to let users know which bills to pay on which period, the method comprising the steps of:
a. receiving input data an investment rate retrieved from a financial study/projection of the household;
b. receiving input data present loan rates of the household which may be retrieved from bank's historical data;
c. receiving input data expenses of the household which may be retrieved from daily life records; and
d. receiving input data unpredicted expenses of the household, as they occur.

7. A computer program comprising program code stored on a computer-readable medium, which when executed, enables a computer system to implement the following steps, in a system having a meeting scheduling service, for maximizing the annual profit of a household micro-economy, the system further having a component to analyze and organize the resulting optimized data to create graphics for a user to view and analyze, and a component to create a table to let the user know which bills to pay on which period, the table having support variables, Costs[j] and pay[i, j, k], Costs[j] representing the summation of the bills which are to be paid on period j (not necessarily the total value of all of the originally incurred on period j), and pay[i, j, k] is a binary variable to decide if the ith bill from period j will be paid in period k, where k>=i, the system further having a component which implements the simplex algorithm to read and solve the model of the present invention with the provided input data and a component to analyze and organize the resulting optimized data to create graphics similar to the ones have been presented; and to create a table to let users know which bills to pay on which period, the method comprising the steps of:
a. deciding whether it is convenient to pay a bill in the current period or postpone it to the next month in order to invest that money;
b. deciding if it is worth to take a low-rate loan in the current period in order to make an investment due to a high investment return rate; and
c. deciding how much on each period should be invested to enhance the earnings.
